(19) United States
(12) Patent Application Publication
(10) Pub. No.: US 2020/0326492 A1
(43) Pub. Date: Oct. 15, 2020

(54) LIGHT GUIDE WITH USB INTERFACE

(71) Applicant: ProTVSolutions LLC, Temecula, CA (US)

(72) Inventor: Guillermo Castano, Tijuana (MX)

(21) Appl. No.: 16/845,822

(22) Filed: Apr. 10, 2020

Related U.S. Application Data
(60) Provisional application No. 62/833,615, filed on Apr. 12, 2019.

(51) Int. Cl. G02B 6/42; H04N 21/41; H01R 13/717; G06F 13/42; H04B 10/25

(52) U.S. Cl. CPC G02B 6/4261; H04N 21/4122; H01R 13/7172; G06F 2213/0042; H04B 10/25; G02B 6/4214; G06F 13/4282

(57) ABSTRACT

The present invention is directed, in part, to a receiver for an infrared light source that uses a USB port to communicate with a set top box or set back box. The receiver comprises a body; a sensor for receiving infrared light; and a substantially planar first surface on the body; which are in communication with via USB with another device. The first surface is configured to direct light from the infrared light source to the sensor. The substantially planar first surface comprises the end of the body. The substantially planar first surface provides an internally reflective surface that directs light into the interior of the body so it will make contact with the sensor.

### CLAIM OF PRIORITY

This application claims the benefit of U.S. Provisional Application No. 62/833,615, filed Apr. 12, 2019, the content of which is herein incorporated by reference in its entirety.

### FIELD OF THE INVENTION

The present invention is directed to guides. More specifically, the invention is directed to light guides for use in transmitting infrared (IR) light signals from a remote to an electronic device.

### BACKGROUND

Setup boxes, such as cable and satellite tuners, may be installed hidden from the user and thus require an external IR receiver to get the remote control signals for operation. Current standard IR receivers are placed on the front of the TV and are easy to bump off during cleaning. In hotels, these sensors may be confused with hidden cameras and become a privacy issue. Therefore, a need exists for a low profile reflective IR receiver that improves on the standard by implementing a near invisible process.

### SUMMARY OF THE INVENTION

The present application is directed to set top or set back boxes (STB's) that don't have an external IR connector available, so that those boxes can be hidden either behind the TV or in a cabinet or closet. Most STB's that don't have this connector do a USB connector. Code in the STB can be added, if it doesn't already exist, to allow for it to understand HID commands. In such situations the present device allows for those boxes to be hidden out of sight and fully function.

Currently with boxes that have the external IR connector, they plug in our Remote Prism to it and then they can hide the box. With the present device, they would plug it into the USB connector and then a light guide (prism, for example) on it.

In the current video electronics environment, the use of small computers has become common as means to retrieve Internet based content for display and access on regular television sets. To navigate the different menu options often requires a computer keyboard, mouse or a custom remote control. The user would still require the standard TV remote control for most local functions such as power and volume control.

The device of the present disclosure is an interface that provides an alternative to the additional control requirements and by just utilizing the standard TV remote control the user gets a simple an integrated experience. In some implementations the substantially planar surface of the body comprises substantially all of an end of the body. Typically, the substantially planar surface of the body is located opposite the sensor. The body may be formed of a polymeric material. Generally, the body is at least two times as long as it is wide, optionally at least three times as long as it is wide.

The device can include, for example, an IR sensor, a light directing prism that may be mounted on the back or bottom of the TV, becoming nearly invisible, cable extension, such as with a 3.5 mm stereo jack cable and a USB module.

Typically the USB module is connected to a USB port on the set top box. It will be in some embodiments identified as a keyboard.

The USB module can be used with, for examples, Windows Machines, Devian Linux based Set top boxes and Android 4.x set top boxes. Generally the USB module is able to decode multiple popular IR remote protocols. An optional key mapping between the remote control and the keyboard interface is as follows:

Numeric Keys (0-9)

Select Key maps as Enter

Navigation Keys map as directional Keys

Home/Menu maps as Home key

Exit key maps as ESC key

Channel up maps as Page Up

Channel Down maps as Page Down

Additional keys or change on the mapping is possible after defining the requirement.

The possible key mapping is only limited by the HID Keyboard assignments as shown on the next page.

Further the unit may be field updated with minimum requirements; the unit may support multiple IR protocols, and the unit may define macros for single IR code to multiple actions on a set top box.

The present application is further directed, in part, to a receiver for an infrared light source. The receiver comprises an infrared body that is transparent to infrared light (which may not be transparent to visible light in some embodiments); a sensor for receiving infrared light; and a substantially planar front surface on the body. The front surface is configured to direct light from the infrared light source to the sensor. The substantially planar front surface comprises the end of the body. The substantially planar front surface provides an internally reflective surface that directs light into the interior of the body so it will make contact with an infrared sensor.

In some implementations the substantially planar surface of the body comprises substantially all of an end of the body. Typically, the substantially planar surface of the body is located opposite the sensor. The body may be formed of a polymeric material. Generally, the body is at least two times as long as it is wide, optionally at least three times as long as it is wide.

In most implementations the substantially planar surface of the body has an angle of from 30 to 60 degrees relative to an adjacent wall of the body. In the alternative, the substantially planar surface of the body has an angle of from 35 to 55 degrees relative to an adjacent wall of the body. Optionally the substantially planar surface of the body has an angle of from 40 to 50 degrees relative to an adjacent wall of the body. Typically, the substantially planar surface of the body has an angle of from 43 to 47 degrees relative to an adjacent wall of the body, most typically the substantially planar surface of the body has an angle 45 degrees relative to an adjacent wall of the body.

The above summary of the present invention is not intended to describe each discussed embodiment of the present invention. This is the purpose of the figures and the detailed description that follows.

### FIGURES

The invention may be more completely understood in connection with the following drawings, in which:

FIG. 1 shows example components, including a light guide, cable, and USB adapter

FIG. 2A is a perspective view of an IR receiver made in accordance with an implementation of the invention.

FIG. 2B is a side perspective view of an IR receiver made in accordance with an implementation of the invention.

FIG. 3 is a side perspective view of an IR receiver made in accordance with an implementation of the invention, showing a first path for light to enter the IR receiver and travel to a sensor.

FIG. 4 is a side perspective view of an IR receiver made in accordance with an implementation of the invention, showing a second path for light to enter the IR receiver and travel to a sensor.

FIG. 5 is a side perspective view of an IR receiver made in accordance with an implementation of the invention, showing a third path for light to enter the IR receiver and travel to a sensor.

FIG. 6 is a side perspective view of an IR receiver made in accordance with an implementation of the invention, showing a fourth path for light to enter the IR receiver and travel to a sensor.

FIG. 7 is a side perspective view of an IR receiver made in accordance with an alternative implementation of the invention.

FIG. 8 is a side perspective view of an IR receiver made in accordance with an alternative implementation of the invention.

FIG. 9 is a side perspective view of an IR receiver made in accordance with an implantation of the invention, the IR receiver shown mounted behind and at the top of a stylized electronic device.

FIG. 10 is a side perspective view of an IR receiver made in accordance with an implantation of the invention, the IR receiver shown mounted behind and at the bottom of a stylized electronic device.

FIG. 11 is a side perspective view of an IR receiver made in accordance with an implantation of the invention, the IR receiver shown mounted below and near the front of a stylized electronic device.

FIG. 12 is a front view of an IR receiver made in accordance with an implantation of the invention, the IR receiver shown mounted at the bottom of a stylized electronic device.

While the invention is susceptible to various modifications and alternative forms, specifics thereof have been shown by way of example and drawings, and will be described in detail. It should be understood, however, that the invention is not limited to the particular embodiments described. On the contrary, the intention is to cover modifications, equivalents, and alternatives falling within the spirit and scope of the invention.

### DETAILED DESCRIPTION

The present invention is directed, in part, to a receiver for an infrared light source. The receiver comprises a body; a sensor for receiving infrared light; and a substantially planar first surface on the body. The first surface is configured to direct light from the infrared light source to the sensor. The substantially planar first surface comprises the end of the body. The substantially planar first surface provides an internally reflective surface that directs light into the interior of the body so it will make contact with the sensor.

In some implementations the substantially planar surface of the body comprises substantially all of an end of the body. Typically, the substantially planar surface of the body is located opposite the sensor. The body may be formed of a polymeric material. Generally, the body is at least two times as long as it is wide, optionally at least three times as long, as it is wide.

In most implementations the substantially planar surface of the body has an angle of 30 to 60 degrees relative to an adjacent wall of the body. In the alternative, the substantially planar surface of the body has an angle of 35 to 55 degrees relative to an adjacent wall of the body. Optionally the substantially planar surface of the body has an angle of 40 to 50 degrees relative to an adjacent wall of the body. Typically, the substantially planar surface of the body has an angle of 43 to 47 degrees relative to an adjacent wall of the body. Most typically the substantially planar surface of the body has an angle 45 degrees relative to an adjacent wall of the body.

In certain embodiments the substantially planar first surface has a surface area at least 50 percent the cross sectional surface area of the body, the cross section taken in a plane perpendicular to a line intersecting the substantially planar first surface of the body and the sensor. Optionally, the substantially planar first surface has a surface area at least 100 percent the cross sectional surface area of the body, the cross section take in a plane perpendicular to a line intersecting the substantially planar first surface of the body and the sensor. In some implementations the substantially planar first surface has a surface area at least 150 percent the cross sectional surface area of the body, the cross section taken in a plane perpendicular to a line intersecting the substantially planar first surface of the body and the sensor.

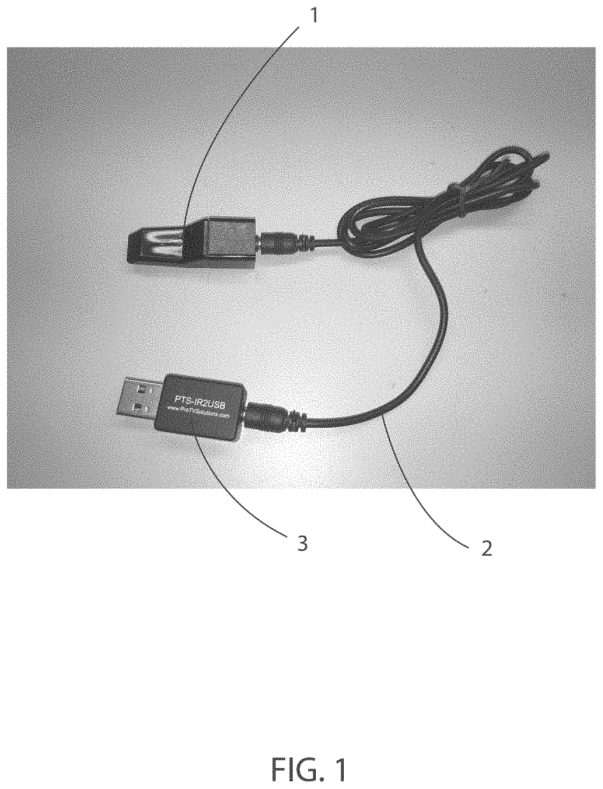

Now, in reference to the drawings, FIG. 1 shows a system including IR Sensor and light guide 1, with light guide (prism) that may be mounted on the back or bottom of the TV, becoming nearly invisible; cable extension 2, and USB module 3. The device of the present disclosure is an interface that provides an alternative to the additional control requirements and by just utilizing the standard TV remote control the user gets a simple an integrated experience. In some implementations the substantially planar surface of the body comprises substantially all of an end of the body. Typically, the substantially planar surface of the body is located opposite the sensor. The body may be formed of a polymeric material. Generally, the body is at least two times as long as it is wide, optionally at least three times as long as it is wide.

The device can include, for example, an IR sensor, a light directing prism that may be mounted on the back or bottom of the TV, becoming nearly invisible, cable extension, such as with a 3.5 mm stereo jack cable and a USB module.

Typically the USB module is connected to a USB port on the set top box. It will be in some embodiments identified as a keyboard.

The USB module can be used with, for examples, Windows Machines, Devian Linux based Set top boxes and Android 4.x set top boxes. Generally the USB module is able to decode multiple popular IR remote protocols. An optional key mapping between the remote control and the keyboard interface is as follows:

Numeric Keys (0-9)

Select Key maps as Enter

Navigation Keys map as directional Keys

Home/Menu maps as Home key

Exit key maps as ESC key

Channel up maps as Page Up

Channel Down maps as Page Down

Additional keys or change on the mapping is possible after defining the requirement.

The possible key mapping is only limited by the HID Keyboard assignments as shown on the next page.

Further the unit may be field updated with minimum requirements; the unit may support multiple IR protocols, and the unit may define macros for single IR code to multiple actions on a set top box.

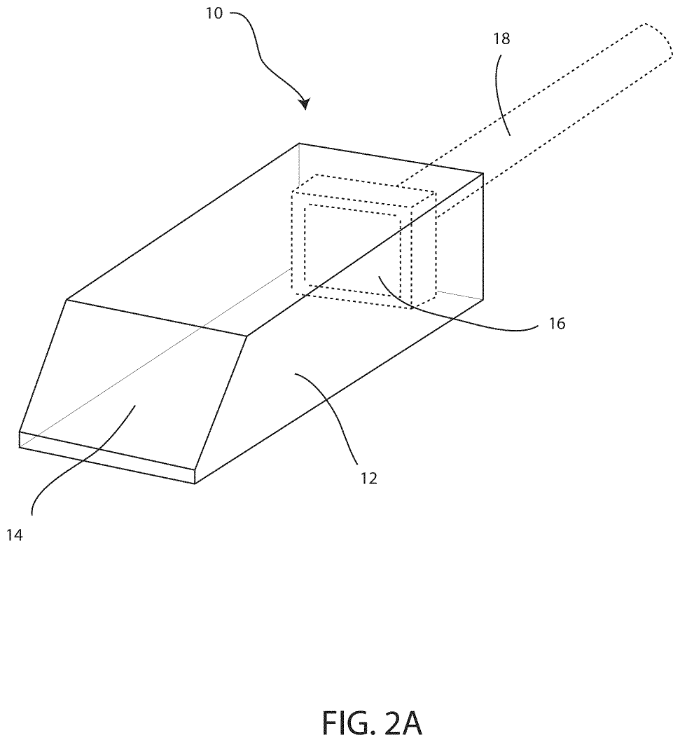

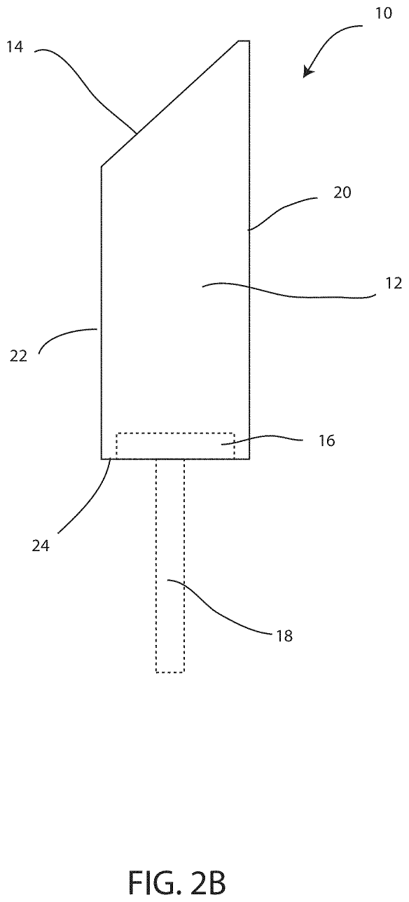

FIG. 2A is a perspective view of an IR receiver 10 made in accordance with an implementation of the invention. The IR receiver 10 includes a body 12, having a substantially planar end surface 14. Inside the body 12 (or at the end opposite to the end surface 14), is positioned a sensor 16, connected by electronic cable or wire 18 to an electronic device (not shown—such as a cable set back box or set top box, a satellite set back box or set top box, or another electronic apparatus that has an IR input). The body 12 may be formed of a polymeric material.

Referring now to FIG. 2B a side perspective view of an IR receiver 10 made in accordance with the implementation of FIG. 2A is shown. The receiver 10 shows a body 12, having a substantially planar end surface 14. The planar end surface 14 is located next to side surfaces 20, 22, and opposite end 24. Inside the body 12 (or at the end of the body 12), is positioned a sensor 16, connected by electronic cable or wire 18.

In most implementations the substantially planar surface of the body has an angle of 30 to 60 degrees relative to an adjacent wall of the body. In the alternative, the substantially planar surface of the body has an angle of 35 to 55 degrees relative to an adjacent wall of the body. Optionally substantially planar surface of the body has an angle of 40 to 50 degrees relative to an adjacent wall of the body. Typically, the substantially planar surface of the body has an angle of from 43 to 47 degrees relative to an adjacent wall of the body. Desirably the substantially planar surface of the body has an angle 45 degrees relative to an adjacent wall of the body.

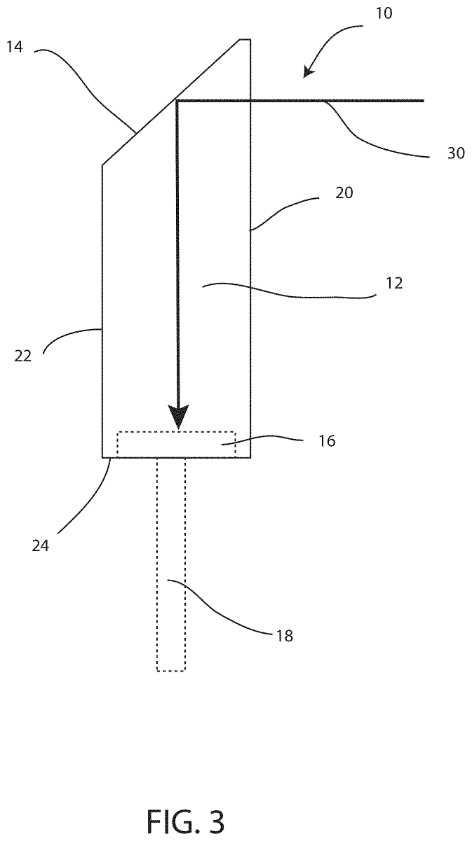

FIG. 3 is a side perspective view of an IR receiver made in accordance with an implementation of the invention, showing a first path for light to enter the IR receiver and travel to a sensor. An example light ray 30 is shown passing through side surface 20, being reflected off of end surface 14, and then directed down to sensor 16.

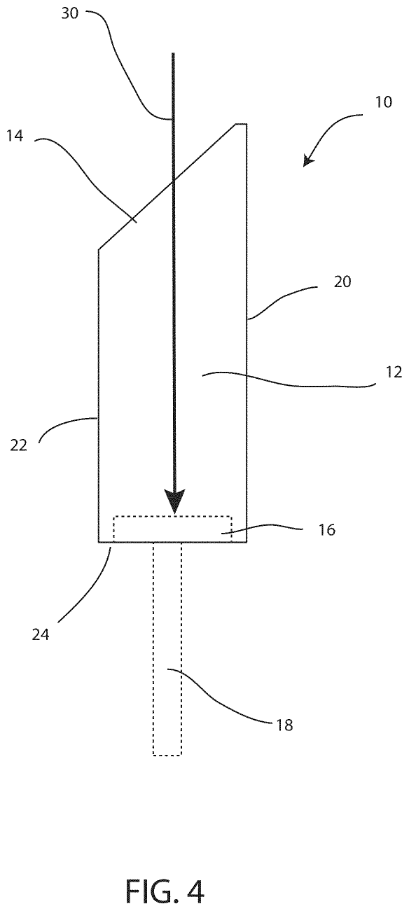

FIG. 4 is a side perspective view of an IR receiver made in accordance with an implementation of the invention, showing a second path for light to enter the IR receiver and travel to a sensor. In this implementation, light enters from the end surface 14 and then passes through the body 12 to the sensor 16. Note that typically the light ray 30 will refract somewhat (counterclockwise in the figure) but will still substantially strike the sensor 16.

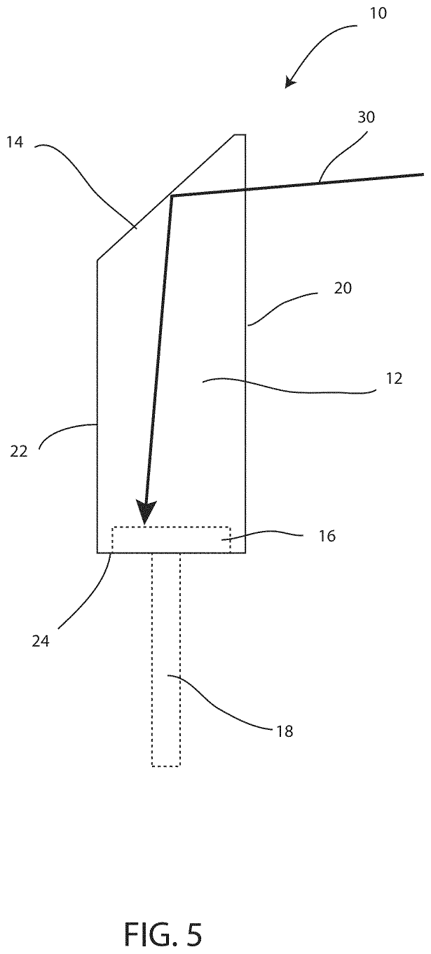

FIG. 5 is a side perspective view of an IR receiver made in accordance with an implementation of the invention, showing an alternate path for light to enter the IR receiver 10 and travel to sensor 16. In this case the light ray 30 enters the body 12 from an angle that is not quite 45 degrees relative to the surface 14. However, in this implementation the light ray 30 still hits the sensor 16.

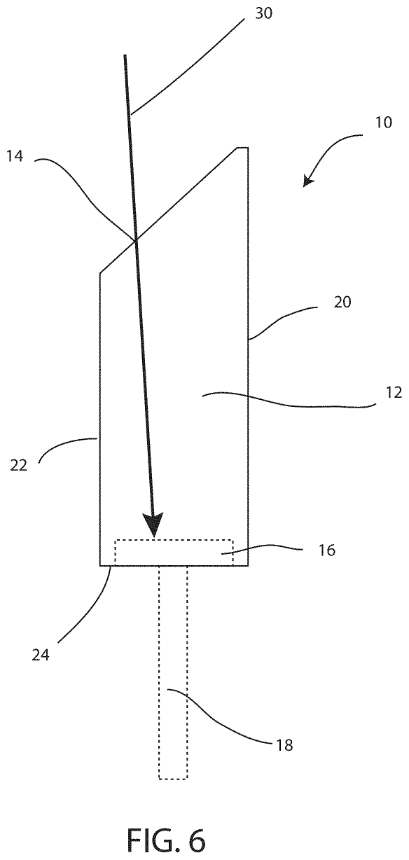

FIG. 6 is a side perspective view of an IR receiver made in accordance with an implementation of the invention, showing an alternate path for light to enter the IR receiver and travel to a sensor. In this implementation, light enters from the end surface 14 and then passes through the body 12 to the sensor 16. Note that typically the light ray 30 will refract somewhat (counterclockwise in the figure) but will still substantially strike the sensor 16

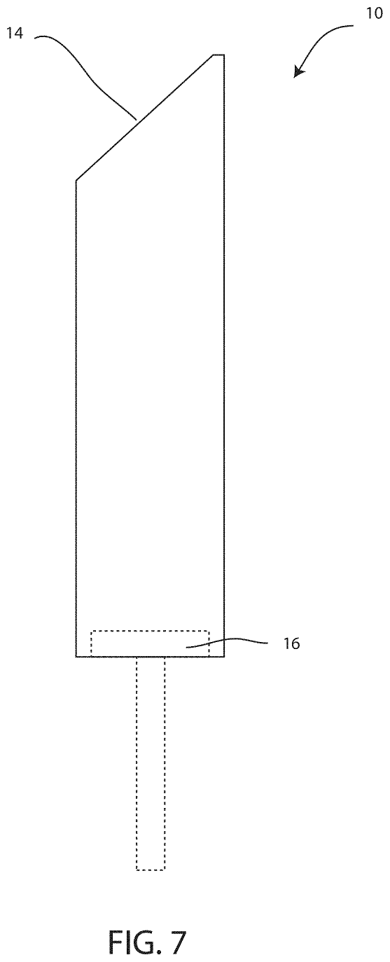

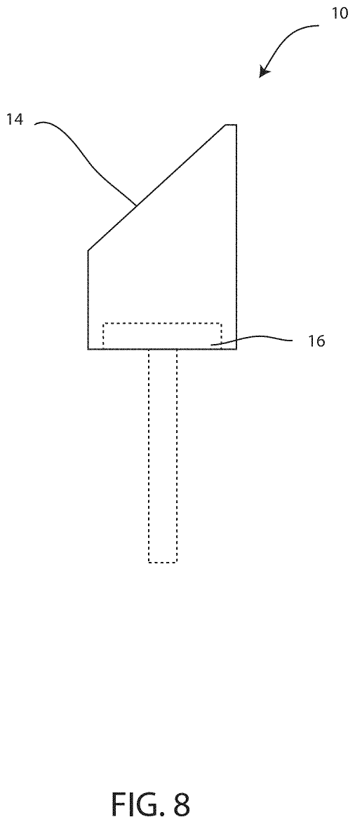

FIG. 7 is a side perspective view of an IR receiver made in accordance with an alternative implementation of the invention, in which the body 12 is relatively elongate compared to the implementation shown in FIG. 2B. FIG. 8 is a side perspective view of an IR receiver made in accordance with an alternative implementation of the invention, in which the body 12 is relatively short compared to the implementation shown in FIG. 2B.

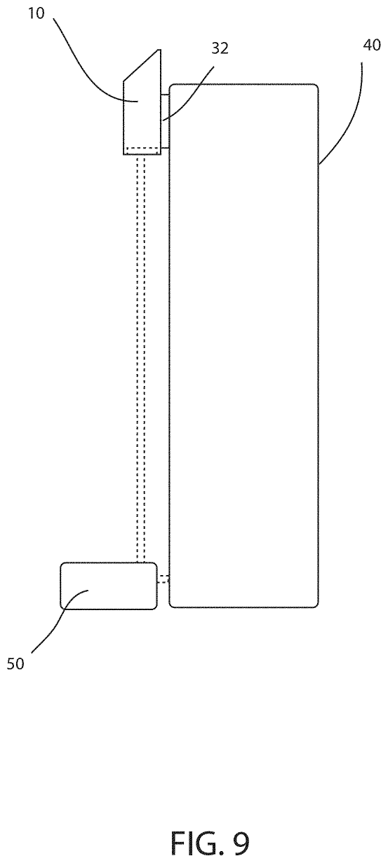

FIG. 9 is a side perspective view of an IR receiver 10 made in accordance with an implantation of the invention, the IR receiver 10 is shown mounted behind and at the top of a stylized electronic device 40 with adhesive strip 32. The IR receiver 10 is connected to an electronic apparatus 50 (such as a cable set back box or set top box, a satellite set back box or set top box, or another electronic apparatus that has an IR input).

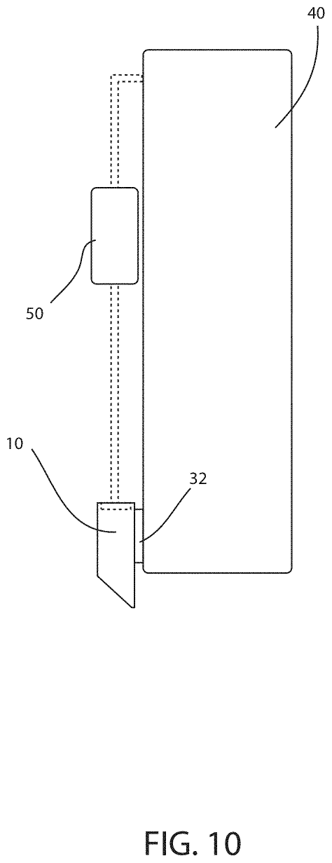

FIG. 10 is a side perspective view of an IR receiver made in accordance with an implantation of the invention, the IR receiver 10 is shown mounted behind and at the bottom of a stylized electronic device, also with adhesive strip 32. The IR receiver 10 is connected to an electronic apparatus 50 (such as a cable set back box or set top box, a satellite set back box or set top box, or another electronic apparatus that has an IR input).

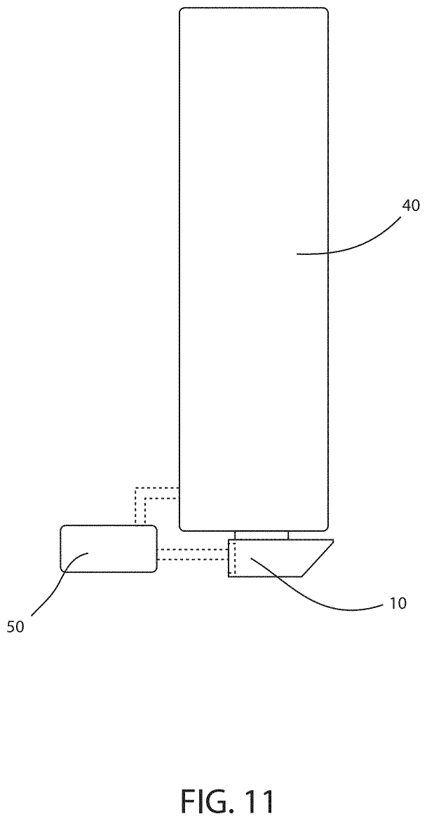

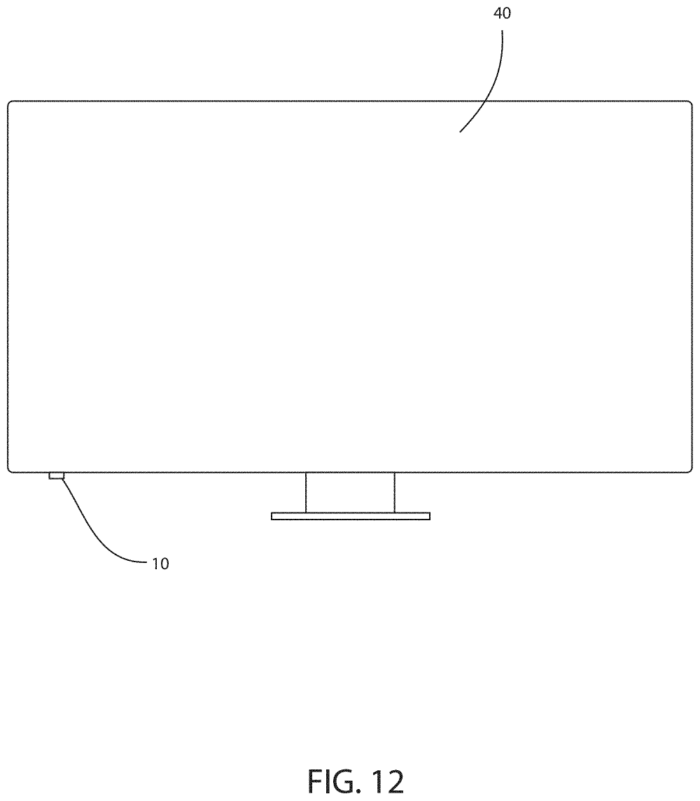

FIG. 11 is a side perspective view of an IR receiver made in accordance with an implantation of the invention, the IR receiver 10 is shown mounted below and near the front of a stylized electronic device 40. The IR receiver 10 is connected to an electronic apparatus 50 (such as a cable set back box or set top box, a satellite set back box or set top box, or another electronic apparatus that has an IR input). In all of the embodiments the portion of the IR receiver 10 visible from the front of the electronic device 40 is relatively small. This low profile aspect is shown in FIG. 12, which is a front view of an IR receiver made in accordance with an implantation of the invention, the IR receiver shown mounted at the bottom of a stylized electronic device.

While the present invention has been described with reference to several particular implementations, those skilled in the art will recognize that many changes may be made hereto without departing from the spirit and scope of the present invention.

We claim:

1. A receiver for an infrared light source, the receiver comprising:
a body;
a sensor for receiving infrared light;
a substantially planar first surface on the body, the first surface configured to direct light from the infrared light source to the sensor; and
a USB interface for connecting to a set top box or set back box.
wherein the substantially planar first surface comprises the end of the body.

2. The receiver for an infrared light source of claim 1, wherein the substantially planar surface of the body comprises substantially all of an end of the body.

3. The receiver for an infrared light source of claim 1, wherein the substantially planar surface of the body is located opposite the sensor.

4. The receiver for an infrared light source of claim 1, wherein the substantially planar surface of the body has an angle of from 30 to 60 degrees relative to an adjacent wall of the body.

5. The receiver for an infrared light source of claim 1, wherein the substantially planar surface of the body has an angle of from 35 to 55 degrees relative to an adjacent wall of the body.

6. The receiver for an infrared light source of claim 1, wherein the substantially planar surface of the body has an angle of from 40 to 50 degrees relative to an adjacent wall of the body.

7. The receiver for an infrared light source of claim 1, wherein the substantially planar surface of the body has an angle of from 43 to 47 degrees relative to an adjacent wall of the body.

8. The receiver for an infrared light source of claim 1, wherein the substantially planar surface of the body has an angle 45 degrees relative to an adjacent wall of the body.

9. The receiver for an infrared light source of claim 1, wherein the body is comprised of a polymeric material.

10. The receiver for an infrared light source of claim 1, wherein the body is at least two times as long as it is wide.

11. The receiver for an infrared light source of claim 1, wherein the body is at least two times as long as it is wide.

12. The receiver for an infrared light source of claim 1, wherein the body is at least three times as long as it is wide.

13. The receiver for an infrared light source of claim 1, wherein substantially planar first surface has a surface area at least 50 percent the cross sectional surface area of the body, the cross section take in a plane perpendicular to a line intersecting the substantially planar first surface of the body and the sensor.

14. The receiver for an infrared light source of claim 1, wherein substantially planar first surface has a surface area at least 100 percent the cross sectional surface area of the body, the cross section take in a plane perpendicular to a line intersecting the substantially planar first surface of the body and the sensor.

15. The receiver for an infrared light source of claim 1, wherein substantially planar first surface has a surface area at least 150 percent the cross sectional surface area of the body, the cross section take in a plane perpendicular to a line intersecting the substantially planar first surface of the body and the sensor.

16. The receiver for an infrared light source of claim 1, wherein the substantially planar first surface provides an internally reflective surface.

17. A receiver for an infrared light source, the receiver comprising:
a body;
a sensor for receiving infrared light;
a surface on the body, the first surface configured to direct light from the infrared light source to the sensor; and
a USB interface for connecting to a set top box or set back box;
wherein the substantially planar first surface provides an internally reflective surface

18. The receiver for an infrared light source of claim 17, wherein the surface of the body configured to direct light from the infrared light source to the sensor comprises substantially all of an end of the body.

19. The receiver for an infrared light source of claim 17, wherein the surface of the body configured to direct light from the infrared light source to the sensor of the body is located opposite the sensor.

20. The receiver for an infrared light source of claim 17, wherein the surface of the body configured to direct light from the infrared light source to the sensor has an angle of from 30 to 60 degrees relative to an adjacent wall of the body.
